(19) United States
(12) Patent Application Publication
(10) Pub. No.: US 2015/0190906 A1
(43) Pub. Date: Jul. 9, 2015

(54) Adjustable Wrench with Reinforced Slidable Jaw

(71) Applicant: New Way Tools Co., Ltd., Taichung City (TW)

(72) Inventor: Ping-Wen Huang, Taichung City (TW)

(73) Assignee: New Way Tools Co., Ltd., Taichung City (TW)

(21) Appl. No.: 14/165,691

(22) Filed: Jan. 28, 2014

(30) Foreign Application Priority Data
Jan. 6, 2014 (TW) 103100340

(51) Int. Cl. B25B 13/14; B25B 23/00

(52) U.S. Cl. CPC B25B 13/14; B25B 23/0007

(57) ABSTRACT

An adjustable wrench includes a handle, a head, a slidable jaw. The head is formed at one end of the handle and includes a fixed jaw, a sliding rail, and a receiving slot. The slidable jaw is slidably disposed in the sliding rail and includes a gripping portion and a reinforced portion. The reinforced portion is formed at a side edge of the gripping portion. The gripping portion has a gripping surface, and the reinforced portion has a first reinforced surface. The first reinforced surface is connected with the gripping surface to form a first included angle greater than 90 degrees. A worm gear is received in the receiving slot and engaged with the slidable jaw.

### BACKGROUND OF THE INVENTION

1. Field of the Invention

The present invention relates generally to a wrench and, in particular, to an adjustable wrench.

2. Description of the Related Art

A conventional wrench is a tool used to provide grip and mechanical advantage in applying torque to turn objects, usually rotary fasteners, such as nuts and bolts, or keep them from turning. One type of the wrench is called open end wrench, which has a U-shaped opening to grip two opposite faces of the bolt or nut. This wrench is often double ended, with a different-sized opening at each end. The ends are generally oriented at an angle of around 15 degrees to the longitudinal axis of the handle. This allows a greater range of movement in enclosed spaces by flipping the wrench over. Moreover, an adjustable wrench is a wrench with a jaw of adjustable width, allowing it to be used with different sizes of fastener head rather than just one fastener, as with a conventional open end wrench.

U.S. Pat. No. 8,136,429 discloses an adjustable wrench, which includes a handle, a head, a slidable jaw, an axial rod and a worm gear. The head is formed with a fixed jaw, a sliding rail, and a receiving slot. The slidable jaw has a sliding rod slidably disposed in the sliding rail of the head. The axial rod and the worm gear dispose in the receiving slot of the head, and the worm gear engages with the sliding rod of the slidable jaw to control the movement of the slidable jaw in relation to the fixed jaw so that an opening formed between the fixed and slidable jaw can be adjustable for different sizes of fastener head.

FIGS. 9 through 11 show a slidable jaw 90 used in the aforementioned adjustable wrench. The slidable jaw 90 substantially includes a gripping portion 91, an engaging portion 92, and a connecting portion 93. The gripping and engaging portions 91 and 92 are disposed at two longitudinal opposite ends of the slidable jaw 90, and the connecting portion 93 is disposed between the gripping and engaging portions 91 and 92. The gripping portion 91 includes a gripping surface 911 extended at a side edge thereof. The gripping surface 911 has a first thickness D1. The engaging portion 92 is engaged with a worm gear (not shown). Thus, a user can rotate the worm gear to drive the slidable jaw 90 sliding with respect to a fixed jaw (not shown). The connecting portion 93 includes a connecting surface 931 extended at a side edge thereof. The connecting surface 931 is curved and connected with the gripping surface 911. The connecting surface 931 has a second thickness D2, which is less than the first thickness D1.

However, when the slidable jaw 90 is used to turn an object, the counter stress produced from the torque applying on the object will concentrate at the connecting surface 931. Thus, a section of the connecting portion 93 adjacent to the gripping portion 91 will be damaged easily due to the curved connecting surface 931 and the second thickness D2 being less than the first thickness D1.

The present invention is, therefore, intended to obviate or at least alleviate the problems encountered in the prior art.

### SUMMARY OF THE INVENTION

In view of the foregoing disadvantages inherent in the known types of adjustable wrench now present in the prior art, the present invention provides an adjustable wrench includes a handle, a head, a slidable jaw, and an adjusting assembly. The head is formed at one end of the handle and includes a fixed jaw, a sliding rail, and a receiving slot interconnected with the sliding rail. The slidable jaw is slidably disposed in the sliding rail of the head and includes a gripping portion, an engaging portion, a connecting portion, and a reinforced portion. The gripping portion and the engaging portion are disposed at two opposite ends of the slidable jaw in a length direction, and the connecting portion is disposed between the gripping portion and the engaging portion. The reinforced portion is formed at side edges of the gripping portion and the connecting portion facing to the fixed jaw. The side edge of the gripping portion has a gripping surface, and the reinforced portion has a first reinforced surface, and then the first reinforced surface is connected with the gripping surface to form a first included angle greater than 90 degrees. The adjusting assembly is rotatably positioned in the receiving slot of the head and includes a worm gear engaged with the engaging portion of the slidable jaw.

In one embodiment of the present invention, the side edge of the connecting portion has a connecting surface, and the reinforced portion is formed between the gripping surface of the gripping portion and the connecting surface of the connecting portion. The reinforced portion further has a second reinforced surface. The first and second reinforced surfaces are coplanar. The second reinforced surface is connected with the connecting surface to form a second included angle greater than 90 degrees.

In another embodiment of the present invention, the side edge of the connecting portion has a connecting surface, and the reinforced portion is formed between the gripping surface of the gripping portion and the connecting surface of the connecting portion. The reinforced portion further has a second reinforced surface. The first and second reinforced surfaces and the connecting surface are coplanar.

In any embodiment of the present invention, the first reinforced surface is provided with a first thickness in a thickness direction perpendicular to the length direction, and the second reinforced surface is provided with a second thickness in the thickness direction. The first thickness is greater than the second thickness.

In any embodiment of the present invention, the gripping portion includes first and second bottom surfaces both facing to the engaging portion. Two opposite ends of the first bottom surface are respectively connected with the second bottom surface and the first reinforced surface. The first bottom surface is provided with a first width in a width direction respectively perpendicular to the thickness and length directions, and the second bottom surface is provided with a second width in the width direction. The first width is greater or less than the second width.

Furthermore, the reinforced portion has a T-shaped cross section in an extending direction, with the extending and the length directions crossing each other to form the first included angle.

The present invention resides not in any one of these features peruse, but rather in the particular combination of all of them herein disclosed and claimed and it is distinguished from the prior art in this particular combination of all of its structures for the functions specified.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

An advantage of the adjustable wrench according to the present invention is that the adjustable wrench includes a slidable jaw provided with a reinforced portion for increasing its structural strength to prevent the slidable jaw to be damaged due to the counter stress produced from the torque applying the object.

Other advantages and features of the present invention will become apparent from the following description referring to the drawings.

### BRIEF DESCRIPTION OF THE DRAWINGS

For the present disclosure to be easily understood and readily practiced, the present disclosure will now be described for the purpose of illustration not limitation, in conjunction with the following figures, wherein:

FIG. 1 shows a perspective view of an adjustable wrench in accordance with a first embodiment of the present invention.

FIG. 2 shows a partial, exploded view of the adjustable wrench of FIG. 1 and, in particular, to shows a slidable jaw of the adjustable wrench of FIG. 1.

FIG. 3 shows a front view of the slidable jaw of the adjustable wrench of FIG. 2.

FIG. 4 shows a side view of the slidable jaw of the adjustable wrench of FIG. 2.

FIG. 5 shows a partial, cross-sectional view of the adjustable wrench of FIG. 1 and illustrates the adjustable wrench gripping an object.

FIG. 6 shows a partial, exploded view of an adjustable wrench in accordance with a second embodiment of the present invention and, in particular, to shows a slidable jaw of the adjustable wrench.

FIG. 7 shows a partial, exploded view of an adjustable wrench in accordance with a third embodiment of the present invention and, in particular, to shows a slidable jaw of the adjustable wrench.

FIG. 8 shows a partial, exploded view of an adjustable wrench in accordance with a fourth embodiment of the present invention and, in particular, to shows a slidable jaw of the adjustable wrench.

FIG. 9 shows a perspective view of a slidable jaw of the conventional adjustable wrench.

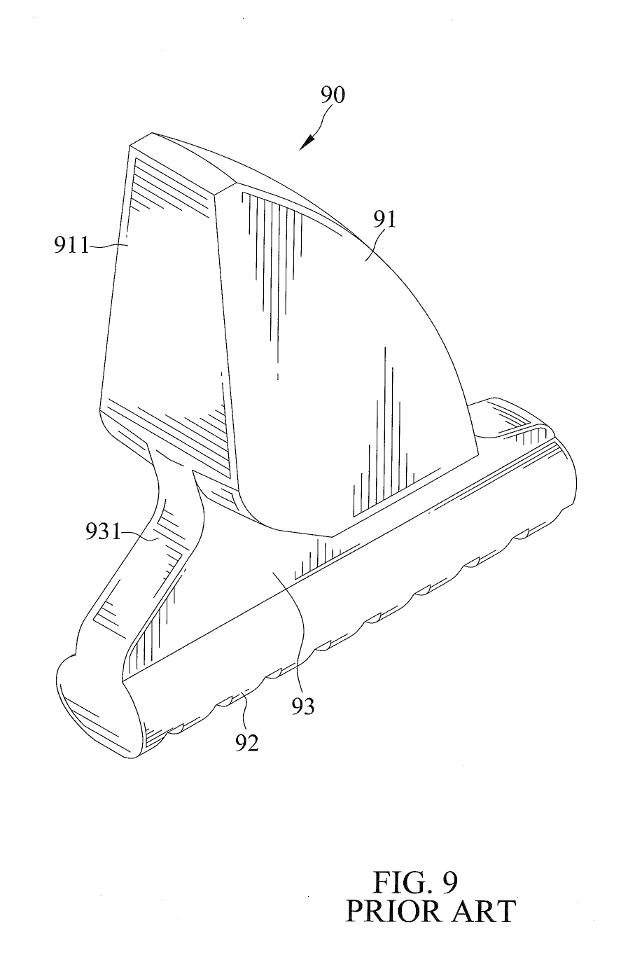

FIG. 10 shows a front view of the slidable jaw of FIG. 9.

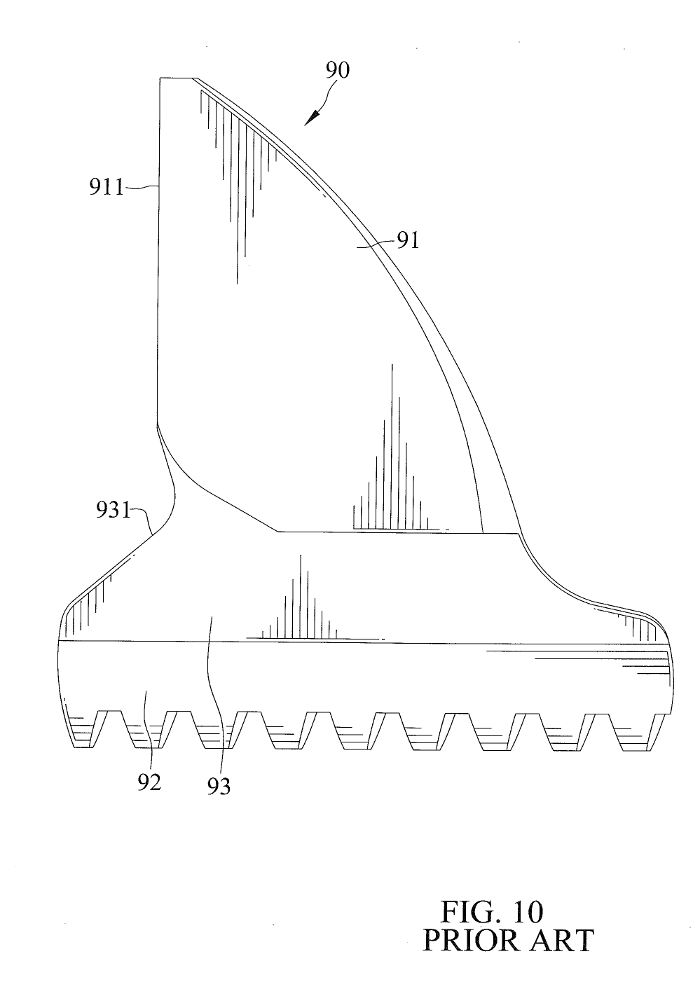

FIG. 11 shows a side view of the slidable jaw of FIG. 9.

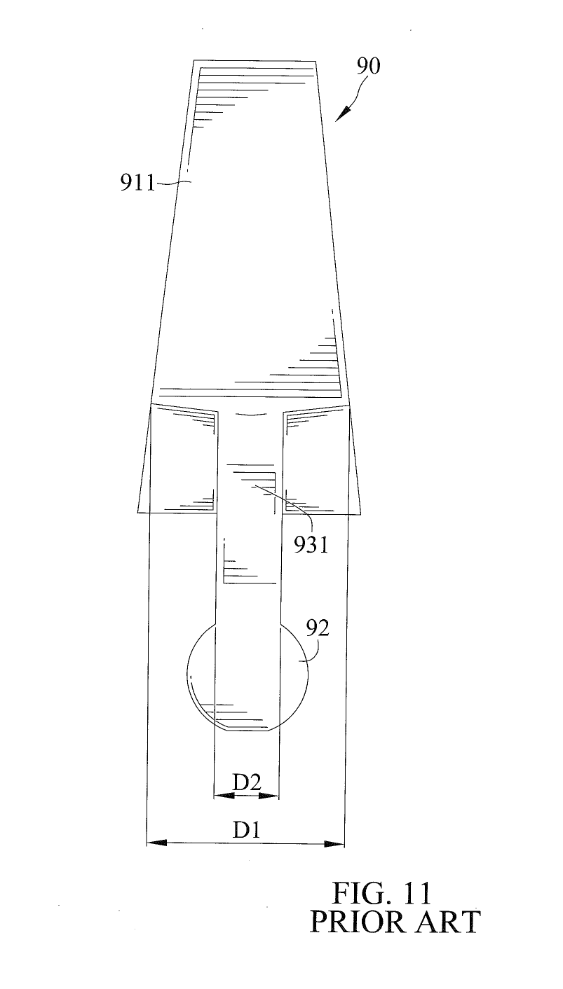

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “inner”, “outer”, “side”, “end”, “portion”, “section”, “longitudinal”, “clockwise”, “counterclockwise”, and similar terms are used herein, it should be understood that these terms have reference only to the structure shown in the drawings as it would appear to a person viewing the drawings and are utilized only to facilitate describing the invention.

### DETAILED DESCRIPTION OF THE PREFERRED EMBODIMENTS

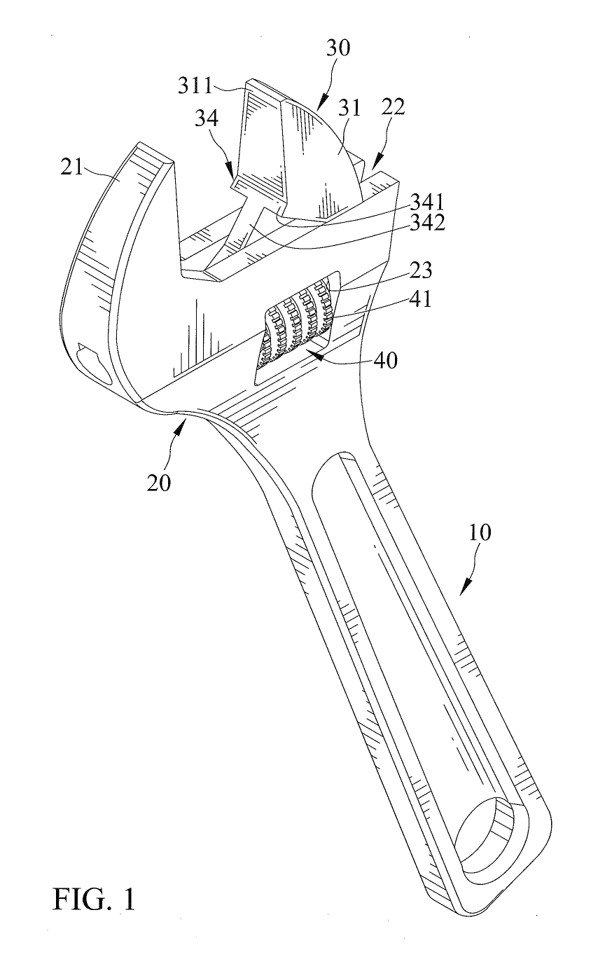

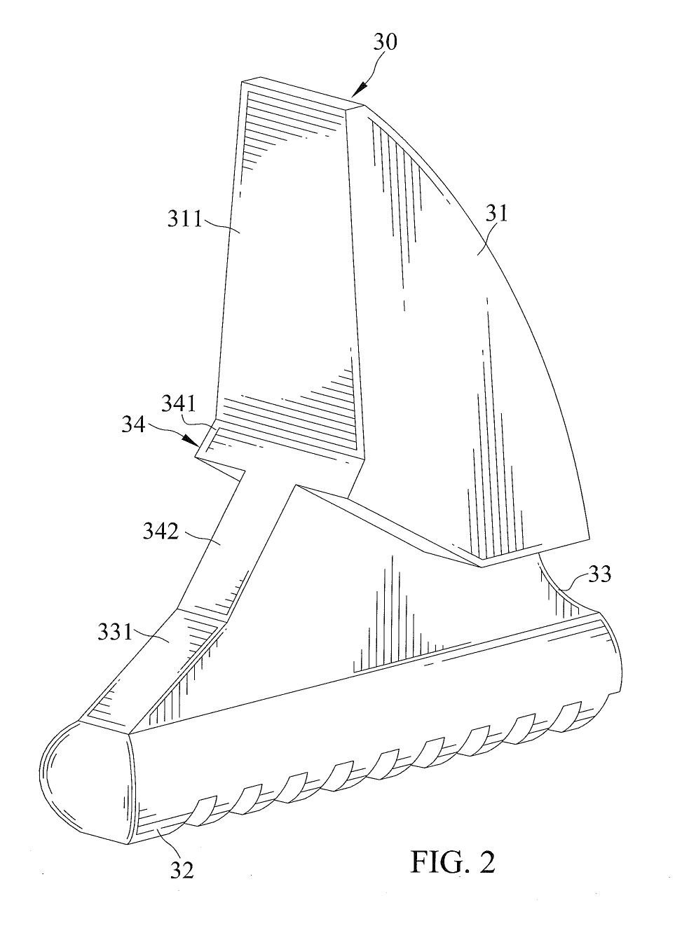

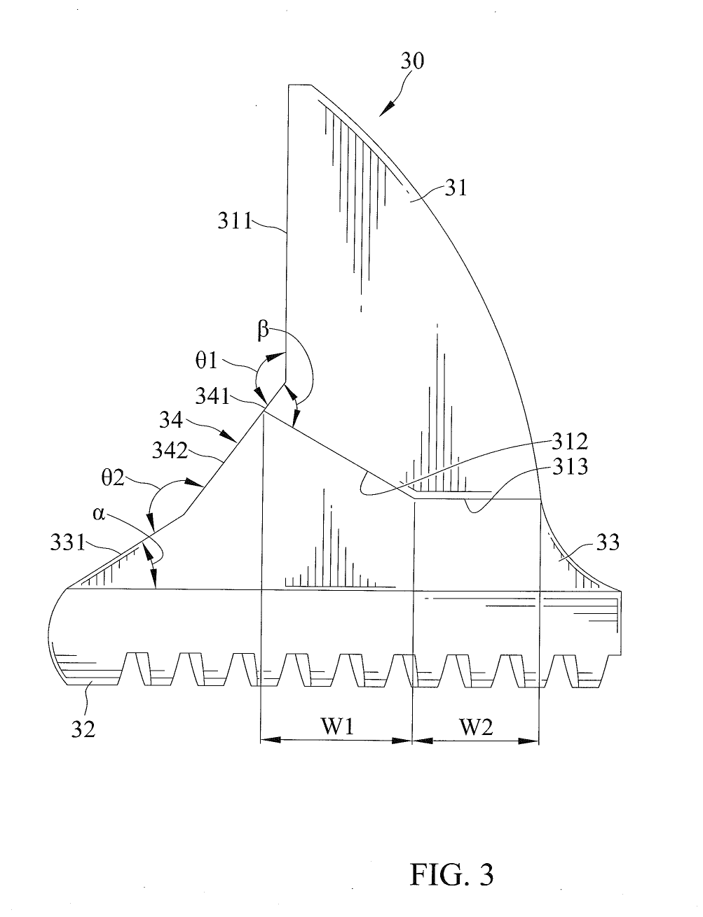

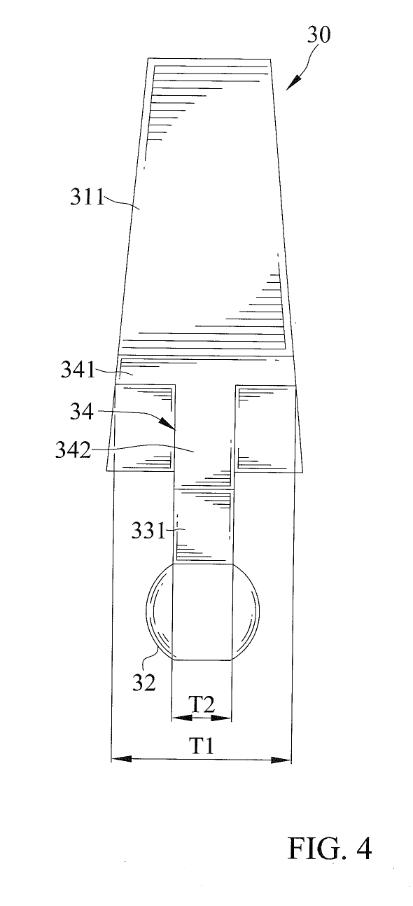

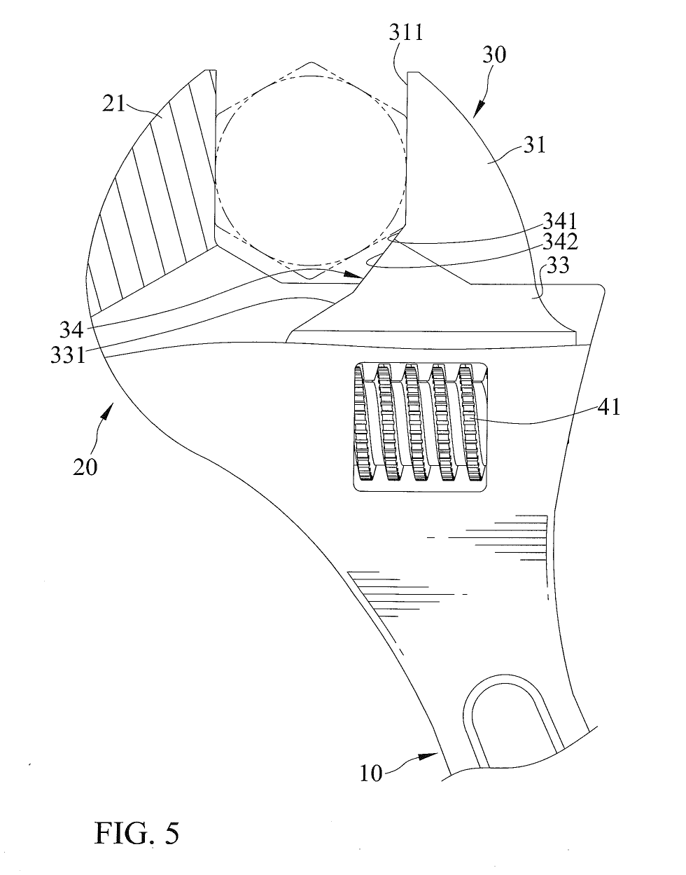

FIGS. 1 through 5 show an adjustable wrench in accordance with a first embodiment of the present invention. The adjustable wrench includes a handle 10, a head 20, a slidable jaw 30, and an adjusting assembly 40.

The handle 10 is adapted for gripped by a user.

The head 20 is formed at one terminal end of the handle 10 and includes a fixed jaw 21, a sliding rail 22, and a receiving slot 23 interconnected with the sliding rail 22. Moreover, another end of the handle 10 may also be provided with another head 20. The fixed jaw 21 is extended in a length direction. The sliding rail 22 is extended in a width direction perpendicular to the length direction.

The slidable jaw 30 is slidably disposed in the sliding rail 22 of the head 20 and includes a gripping portion 31, an engaging portion 32, a connecting portion 33, and a reinforced portion 34. The gripping portion 31 and the engaging portion 32 are disposed at two opposite ends of the slidable jaw 30 in the length direction. The gripping portion 31 is extended in the length direction. The engaging portion 32 is extended in the width direction. The connecting portion 33 is formed between the gripping portion 31 and the engaging portion 32. The reinforced portion 34 is formed at side edges of the gripping portion 31 and the connecting portion 33 facing to the fixed jaw 21. The side edge of the gripping portion 31 has a gripping surface 311 facing to the fixed jaw 21, and the side edge of the connecting portion 33 has a connecting surface 331 facing to the fixed jaw 21, too. The connecting surface 331 of the connecting portion 33 and an end face of the engaging portion 32 adjacent to the connecting portion 33 form an outer included angle α together. The outer included angle α is between 30 and 40 degrees, more accurately, the outer included angle α is 33 degrees. The reinforced portion 34 is formed between the gripping surface 311 of the gripping portion 31 and the connecting surface 331 of the connecting portion 33. The reinforced portion 34 includes first and second reinforced surfaces 341 and 342 formed at a side edge thereof facing to the fixed jaw 21. The first and second reinforced surfaces 341 and 342 are connected with each other to be coplanar. The first reinforced surface 341 is connected with the gripping surface 311 to form a first included angle θ1 greater than 90 degrees. The second reinforced surface 342 is connected with the connecting surface 331 to form a second included angle θ2 greater than 90 degrees.

Moreover, the first reinforced surface 341 has a first thickness T1 in a thickness direction respectively perpendicular to the length and the width directions, and the second reinforced surface 342 has a second thickness T2 in the thickness direction. In the embodiment, the first thickness T1 is greater than the second thickness T2. This, the reinforced portion 34 has a T-shaped cross section in an extending direction. Preferably, the extending and the length directions cross each other to form the first included angle θ1.

Additionally, the gripping portion 31 includes first and second bottom surfaces 312 and 313 both facing to the engaging portion 32. Two opposite ends of the first bottom surface 312 are respectively connected with the second bottom surface 313 and the first reinforced surface 341. The first bottom surface 312 has a first width W1 in the width direction, and the second bottom surface 313 has a second width W2 in the width direction. In the embodiment, the first width W1 is greater than the second width W2. The first bottom surface 312 of the connecting portion 33 and first reinforced surface 341 of the reinforced portion 34 form an inner included angle β together. The inner included angle β is between 75 and 85 degrees, more accurately, the inner included angle β is 83 degrees.

The adjusting assembly 40 is rotatably positioned in the receiving slot 23 of the head 20 and includes a worm gear 41, which is engaged with the engaging portion 32 of the slidable jaw 30. Thus, the user can rotate the worm gear 41 to cause the slidable jaw 30 moving with respect to the fixed jaw 21 to be used with different sizes of objects.

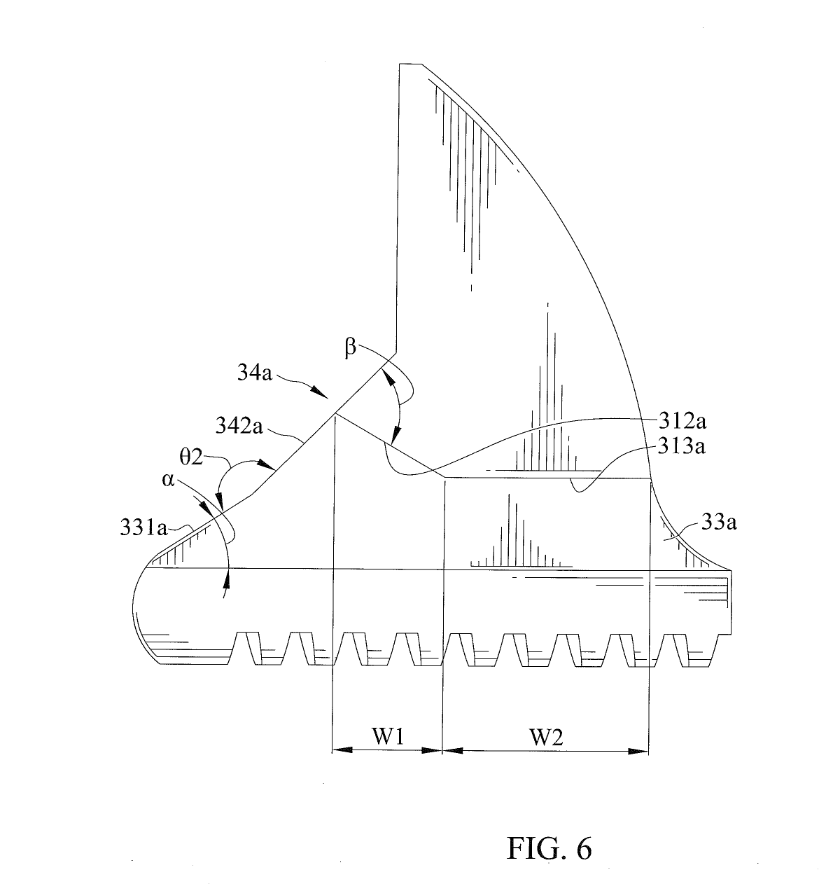

FIG. 6 shows an slidable jaw of an adjustable wrench in accordance with a second embodiment of the present invention. The second embodiment is similar to the first embodiment except that the second included angle θ2 formed between the second reinforced surface 342a of the reinforced portion 34a and the connecting surface 331a of the connecting portion 33a is greater than that of the first embodiment. Moreover, the first width W1 of the first bottom surface 312a is less than the second width W2 of the second bottom surface 313a. In the embodiment, the inner included angle β is 75 degrees.

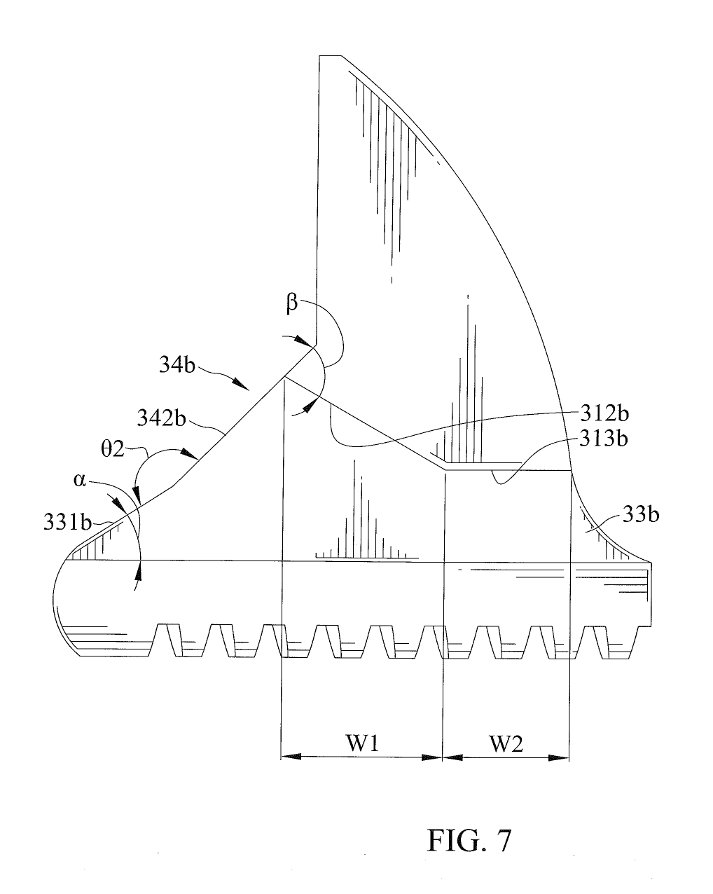

FIG. 7 shows an slidable jaw of an adjustable wrench in accordance with a third embodiment of the present invention. The third embodiment is similar to the first embodiment except that the second included angle θ2 formed between the second reinforced surface 342b of the reinforced portion 34b and the connecting surface 331b of the connecting portion 33b is greater than that of the first embodiment. Similarly, the first width W1 of the first bottom surface 312b is greater than the second width W2 of the second bottom surface 313b.

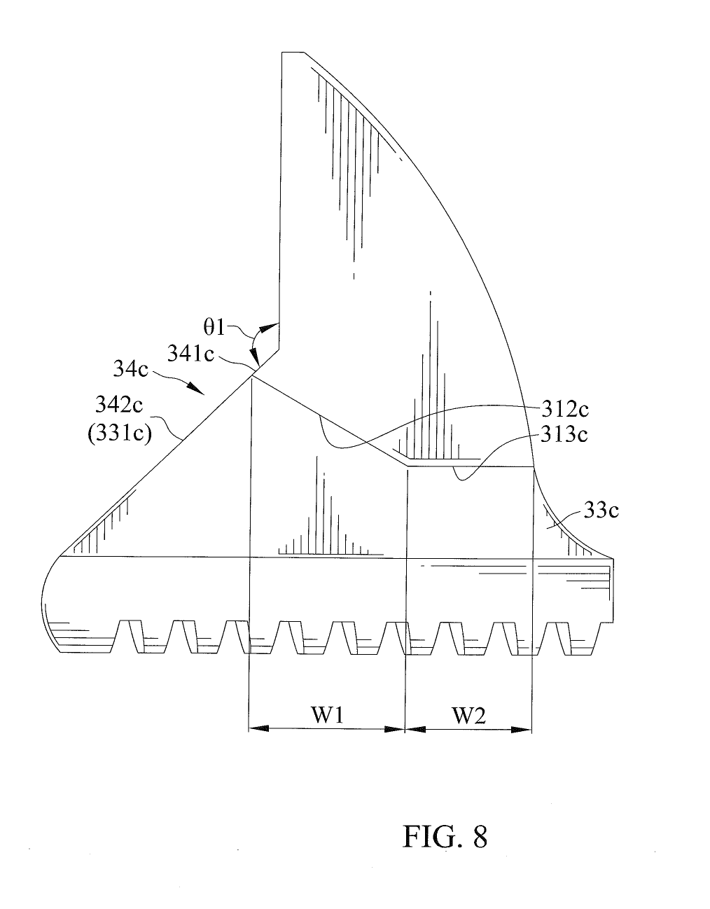

FIG. 8 shows an slidable jaw of an adjustable wrench in accordance with a fourth embodiment of the present invention. The fourth embodiment is similar to the first embodiment except that the first and second reinforced surfaces 341c and 342c of the reinforced portion 34c and the connecting surface 331c of the connecting portion 33c are connected with each other to be coplanar. Similarly, the first width W1 of the first bottom surface 312c is greater than the second width W2 of the second bottom surface 313c.

In view of the forgoing, it is an object of the present invention to provide an adjustable wrench that includes a slidable jaw 30 provided with a reinforced portion 34, 34a, 34b, and 34c for increasing its structural strength to prevent the slidable jaw 30 to be damaged due to the counter stress produced from the torque applying the object.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. An adjustable wrench comprising:
a handle;
a head formed at one end of the handle and including a fixed jaw, a sliding rail, and a receiving slot interconnected with the sliding rail;
a slidable jaw slidably disposed in the sliding rail of the head and including a gripping portion, an engaging portion, a connecting portion, and a reinforced portion, with the gripping portion and the engaging portion disposed at two opposite ends of the slidable jaw in a length direction, with the connecting portion disposed between the gripping portion and the engaging portion, with the reinforced portion formed at side edges of the gripping portion and the connecting portion facing to the fixed jaw, with the side edge of the gripping portion having a gripping surface, with the reinforced portion having a first reinforced surface, with the first reinforced surface connected with the gripping surface to form a first included angle greater than 90 degrees; and
an adjusting assembly rotatably positioned in the receiving slot of the head and including a worm gear, with the worm gear engaged with the engaging portion of the slidable jaw.

2. The adjustable wrench as claimed in claim 1, wherein the side edge of the connecting portion has a connecting surface, with the reinforced portion formed between the gripping surface of the gripping portion and the connecting surface of the connecting portion, with the reinforced portion further having a second reinforced surface, with the first and second reinforced surfaces being coplanar, with the second reinforced surface connected with the connecting surface to form a second included angle greater than 90 degrees.

3. The adjustable wrench as claimed in claim 1, wherein the side edge of the connecting portion has a connecting surface, with the reinforced portion formed between the gripping surface of the gripping portion and the connecting surface of the connecting portion, with the reinforced portion further having a second reinforced surface, with the first and second reinforced surfaces, and the connecting surface being coplanar.

4. The adjustable wrench as claimed in claim 2, wherein the first reinforced surface is provided with a first thickness in a thickness direction, with the thickness direction perpendicular to the length direction, and wherein the second reinforced surface is provided with a second thickness in the thickness direction, with the first thickness being greater than the second thickness.

5. The adjustable wrench as claimed in claim 3, wherein the first reinforced surface is provided with a first thickness in a thickness direction, with the thickness direction perpendicular to the length direction, and wherein the second reinforced surface is provided with a second thickness in the thickness direction, with the first thickness being greater than the second thickness.

6. The adjustable wrench as claimed in claim 4, wherein the gripping portion includes first and second bottom surfaces both facing to the engaging portion, with two opposite ends of the first bottom surface respectively connected with the second bottom surface and the first reinforced surface, wherein the first bottom surface is provided with a first width in a width direction, with the width direction respectively perpendicular to the thickness and length directions, and wherein the second bottom surface is provided with a second width in the width direction, with the first width being greater than the second width.

7. The adjustable wrench as claimed in claim 5, wherein the gripping portion includes first and second bottom surfaces both facing to the engaging portion, with two opposite ends of the first bottom surface respectively connected with the second bottom surface and the first reinforced surface, wherein the first bottom surface is provided with a first width in a width direction, with the width direction respectively perpendicular to the thickness and length directions, and wherein the second bottom surface is provided with a second width in the width direction, with the first width being greater than the second width.

8. The adjustable wrench as claimed in claim 4, wherein the gripping portion includes first and second bottom surfaces both facing to the engaging portion, with two opposite ends of the first bottom surface respectively connected with the second bottom surface and the first reinforced surface, wherein the first bottom surface is provided with a first width in a width direction, with the width direction respectively perpendicular to the thickness and length directions, and wherein the second bottom surface is provided with a second width in the width direction, with the first width being less than the second width.

9. The adjustable wrench as claimed in claim 1, wherein the reinforced portion has a T-shaped cross section in an extending direction, with the extending and the length directions crossing each other to form the first included angle.

10. The adjustable wrench as claimed in claim 1, wherein the connecting surface of the connecting portion and an end face of the engaging portion adjacent to the connecting portion form an outer included angle between 30 and 40 degrees

11. The adjustable wrench as claimed in claim 7, wherein the first bottom surface of the connecting portion and first reinforced surface of the reinforced portion form an inner included angle between 75 and 85 degrees.
